(19) United States
(12) Patent Application Publication
(10) Pub. No.: US 2010/0288990 A1
(43) Pub. Date: Nov. 18, 2010

(54) STANCHION WITH DISPLAY DEVICE

(76) Inventors: Alan McPherson, Milton Keynes (GB); Georgina Rogers, West Sussex (GB); Andy Finch, Leicestershire (GB)

Correspondence Address: OSTROLENK FABER GERB & SOFFEN, 1180 AVENUE OF THE AMERICAS, NEW YORK, NY, 100368403, US

(21) Appl. No.: 12/686,230

(22) Filed: Jan. 12, 2010

Related U.S. Application Data
(60) Provisional application No. 61/178,425, filed on May 14, 2009.

(51) Int. Cl. E04H 17/20; G09G 3/36; G06F 3/041

(52) U.S. Cl. 256/65.01; 345/87; 345/173

(57) ABSTRACT

A stanchion for use in a barrier system in accordance with an embodiment of the present application includes a display device mounted at substantially eye level such that it is easily viewed by a user waiting in line in the barrier system. The display device may include interactive features to track user position or allow users to request information, input information or to conduct transactions while on line.

### CROSS-REFERENCE TO RELATED APPLICATIONS

The present application claims benefit of and priority to U.S. Provisional Patent Application Ser. No. 61/178,425 filed on May 14, 2009 entitled QUEUE SYSTEM INCLUDING BOUNDARY POLE WITH DISPLAY DEVICE, the entire contents of which are hereby incorporated by reference herein.

### BACKGROUND

1. Field of the Disclosure

The present disclosure relates to a stanchion in a barrier, or queue, system that includes an interactive video display.

2. Related Art

Unfortunately, in a variety of settings, people are forced to spend relatively long periods of time waiting in line whether it be at the bank, at the airport, or even at the cashier of a retail store. It is common to use a barrier system including a plurality of stanchions, between which a retractable web, or other barrier, extends to link one stanchion to an adjacent stanchion, and thus, guide users in forming the line, or queue. In some cases, merchandise may be displayed on the barrier itself. Providing this merchandise to the customer as they wait on line increases their exposure to it and often leads to additional sales.

Various stores or other businesses have introduced video display devices, for example, at the checkout counter, or cashier, for example, as a means of conveying information to users. While these displays do provide the user with information, they are generally rather far away from the user as they stand on line and may be difficult to view. Further, these devices do not offer the user information regarding merchandise that is nearby, for example, the merchandise that is displayed on the barriers. Thus, these devices do little to encourage additional sales. There is also no opportunity to provide for interaction between users and the display.

Accordingly, it would be beneficial to provide a barrier system that addresses these problems.

### SUMMARY

It is an object of the present application to provide a barrier system in which at least one stanchion includes a video display positioned for easy viewing by users waiting in line.

A barrier system in accordance with an embodiment of the present application includes a plurality of stanchions, a connector extending between at least two of the plurality of stanchions and at least one display stanchion. The display stanchion includes a base, a vertical post extending up from the base, and a display device mounted on the vertical post at substantially eye level.

A stanchion for use in a barrier system in accordance with another embodiment of the present application includes a base, a vertical post extending up from the base, and a display device mounted on the vertical post a substantially eye level.

A stanchion for use in a barrier system in accordance with another embodiment of the present application includes a base, vertical post extending up from the base, and a display device mounted on the vertical post at substantially eye level, wherein the display device is a touch screen display operable to allow a user to input information.

Other features and advantages of the present invention will become apparent from the following description of the invention which refers to the accompanying drawings.

### BRIEF DESCRIPTION OF THE DRAWINGS

FIG. 1 is an exemplary illustration of a barrier system in which a display stanchion of the present application may be used in accordance with an embodiment of the present application.

FIG. 2 is a more detailed view of a display stanchion in accordance with an embodiment of the present application.

FIG. 3 is an exemplary block diagram of a display device of a display stanchion in accordance with an embodiment of the present application.

FIG. 4 is an exemplary illustration of a barrier system in which a display stanchion of the present application may be used in accordance with another embodiment of the present application.

FIG. 5 is a more detailed front view of a display stanchion in accordance with another embodiment of the present application.

FIG. 6 is a more detailed rear view of the display stanchion of FIG. 5.

FIG. 7 illustrates a barrier system in which display stanchions of the present application may be used in accordance with another embodiment of the present application

### DETAILED DESCRIPTION OF THE EMBODIMENTS

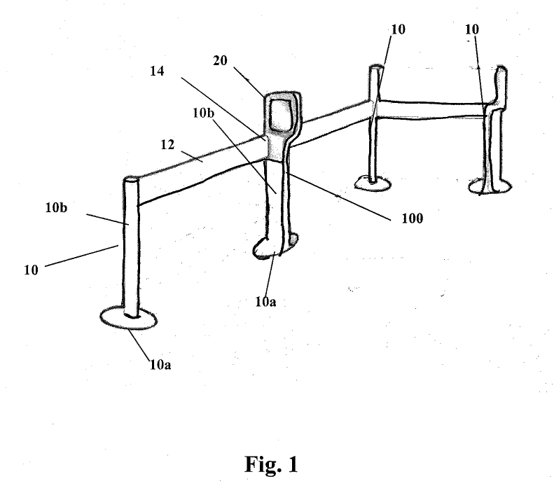

FIG. 1 illustrates a portion of a barrier system, or queue system, 1 that includes a plurality of stanchions 10 between which a flexible web 12 extends to define the queue for a line. The web 12 may be a single narrow strip or may be wider strip, if desired.

A stanchion 10 in accordance with a preferred embodiment of the present application preferably includes a base 10a from which a vertical post 10b extends upward. In a preferred embodiment, a web housing 14 may be provided to accommodate the web 12. The web housing 14 may provide for extension and retraction of the web 12.

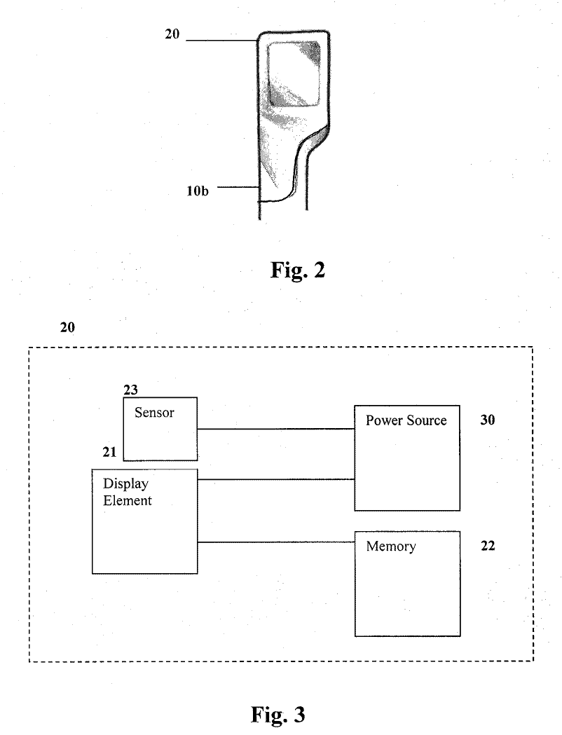

In a preferred embodiment, at least one stanchion 10 is a display stanchion 100, illustrated in further detail in FIG. 2, for example, that also includes a display device 20 preferably mounted on the vertical post 10b. The display device 20 is operable to display information to users waiting in line. This information may include advertising information, product and service information, waiting time information, customer service information or any other desired information. Generally, the advertising information is related to products or services available in the location of the system 1, however, it may be related to any desired products or services. There may be several display stanchions 100 provided amongst the plurality of stanchions 10 in the barrier system 1. In addition, If desired, all of the stanchions 10 may be display stanchions. While 4 stanchions 10, 100 are shown in FIG. 1, any desired number of stanchions 10, 100 may be used.

The display device 20 is preferably mounted on the display stanchion 100 at substantially eye level such that it is easily viewed by those standing in line. In a preferred embodiment, the display device 20 is mounted at a height of approximately 1.2 meters, however, this height may be varied provided that the display device 20 is easily viewed by users.

A memory device 22 (See FIG. 3, for example) may be provided in the display device 20, or the stanchion 100, if desired, and is connected to the display device 20 to provide the information to be displayed. Alternatively, a removable memory element, such as an SD card, or any other suitable memory media, may be used to provide the information to the display device 20. In another alternative embodiment, a wired connection may be provided between an external memory device and the display device 20 to provide the displayed information. If desired, a wireless connection may be provided between the external memory device and the display device 20 to provide the information to the display, if desired. In another embodiment, the information may be provided on a streaming basis, via either a wired or wireless connection to an exterior device. This information may include live broadcast TV, for example.

The display device 20 preferably includes a display element 21, as illustrated in the exemplary block diagram of FIG. 3, for example, to actually display the information. The display element 21 may be a liquid crystal display (LCD) device or any other suitable display element. The display element 21 may include light emitting diodes (LEDs), such as an LED back light which may improve efficiency. The display element 21 is connected to the memory device 22. While LCD displays are explicitly described, any display device would be suitable provided that it allows for the presentation of a dynamic, preferably digital, image to users.

The display stanchion 100 may also include a power source 30, as illustrated in FIG. 3, for example, which is used to provide power to the display device 20. The power source 30 may be a battery, rechargeable or otherwise, or any other portable voltage or current source. Alternatively, the power source 30 may be connected via a power cord to a typical AC line source, if desired. The power source may be included in the display 20 or in the stanchion 100 itself.

In another embodiment, the display device 20 may provide interactive features as well. For example, the display device 20 may be a touch screen type display that allows users to input information. In addition, or alternatively, the display device 20 may include a keyboard, numeric keypad, or other input device to allow user's to input information. If desired, a magnetic, bar code or infrared reader may be provided to allow users to access the display device 20. In this manner, secure identification of individual users may be made.

Providing for interactive functionality will allow users to request certain desired information for display. Users may be able to review account balance information, for example, while waiting in line at a bank. Further, the interactive features may be used to allow users to complete certain transactions while still on line, thus reducing or perhaps eliminating the need to talk to service personnel. When the display device 20 includes interactive features, the display device should be positioned not only at eye level but also at a height where a user can easily input information.

In another embodiment, interaction may be provided in a more passive manor. The display device 20 may include one or more sensors 23 (see FIG. 3) that are used to sense the presence of the user. A variety of infra-red and microwave based sensor devices are available that would be suitable to detect a user's presence, however, any suitable sensor may be used. Based on the user's position in line, the display device 20 may provide information regarding waiting time, for example. The sensor 23 may also be used to establish a count of people passing the display device, and thus, be used to track line size or total wait times. In addition, the sensor 23 may be used to turn the display device 20 on. That is, the display device 20 may remain off until the presence of a user is detected by sensor 23, at which time power is provided to activate the display device 20. This will result in substantial power savings. The display device 20 may include a suitable controller to aid in performing these functions, if desired.

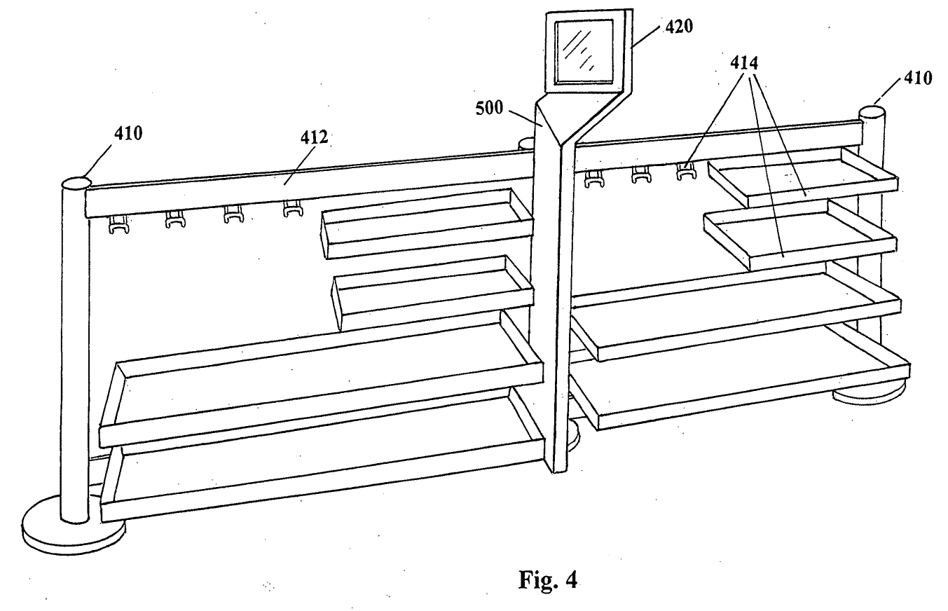

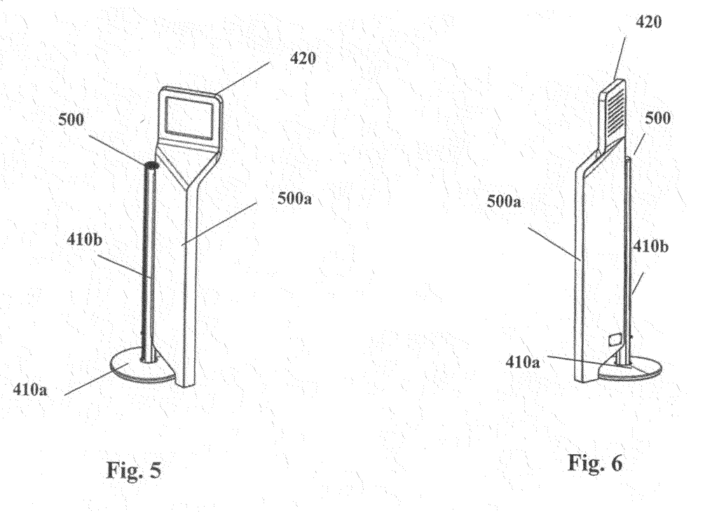

FIG. 4 illustrates an alternative embodiment of a barrier system, or queue system, 401 that includes a plurality of stanchions 410 between which barriers 412 extend to define the queue for a line. In the embodiment illustrated in FIG. 4, the barrier 412 includes racks, shelves or other display elements 414 to allow certain products to be displayed on the barrier itself. The stanchions 410 of the system 400 are similar to the stanchion 10 described above in that they also include a base 410a from which a vertical post 410b extends upward. In a preferred embodiment, at least one display stanchion 500 includes a display device 420. As illustrated in FIG. 5, for example, such display stanchions 500 preferably also includes a display body 500a connected to the post 410b on which the display device 420 is mounted.

FIG. 5 illustrates a more detailed front view of the display stanchion 500 while FIG. 6 illustrates a back view thereof. In a preferred embodiment, a power source (not shown) similar to power source 30 discussed above, to power the display device 420 is provided in the display body 500a. The power source could also be provided in the display device 420 itself, if desired. In addition, the display body 500a may include a memory device 422 (not shown), similar to memory device 22 described above, if desired. The memory device 422 may be provided in the display device 420 itself as well or linked thereto by a wired or wireless connection, if desired.

As is illustrated in FIG. 4, in this embodiment, the display 420 may be used to present advertising, or other information regarding the products that are displayed on the display elements 414. In the alternative, any of the other information discussed above with respect to the display 20 may be displayed on display 420 as well.

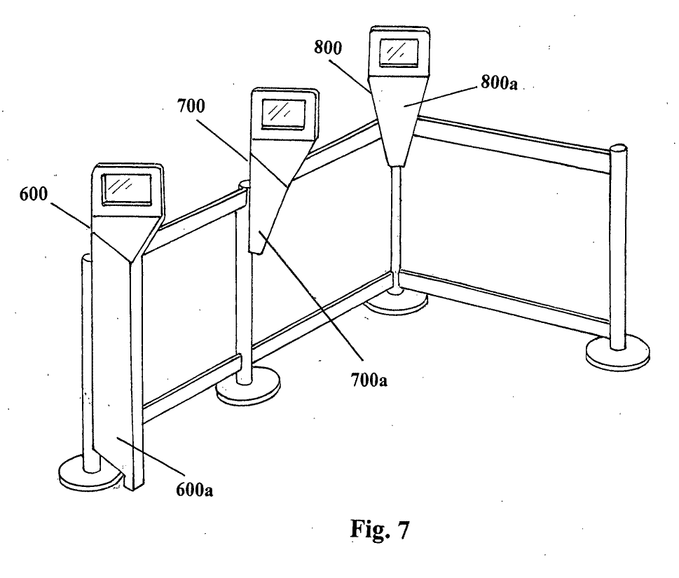

FIG. 7 illustrates another exemplary barrier, or queue, system 601 in which multiple display stanchions 600, 700, and 800 are used. Depending on their position in the system 601, different display bodies 600a, 700a, 800a are used. Otherwise, the stanchions 600, 700, 800 are similar to the display stanchions 100, 500 described above.

Although the present invention has been described in relation to particular embodiments thereof, many other variations and modifications and other uses will become apparent to those skilled in the art.

What is claimed is:

1. A barrier system comprising:
a plurality of stanchions;
a connector extending between at least two of the plurality of stanchions; and
at least one display stanchion further comprising:
a base;
a vertical post extending up from the base; and
a display device mounted on the vertical post at substantially eye level.

2. The barrier system of claim 1, wherein the display device is a liquid crystal display.

3. The barrier system of claim 1, wherein the at least one display stanchion further comprises a memory element operable to store information for display on the display device.

4. The barrier system of claim 4, wherein the at least one display stanchion further comprises a power source operable to power the display device.

5. The barrier system of claim 4, wherein the display device is a touch screen display operable to allow a user to input information.

6. The barrier system of claim 4, wherein the display device further comprises at least one input device operable to input information into the display device.

7. The barrier system of claim 4, wherein the display device further comprises a sensor configured and operable to detect a user's presence near the display device.

8. The barrier system of claim 7, wherein the power provided to the display device is controlled based on the presence of the user near the display stanchion.

9. The barrier system of claim 1, wherein the connector is a retractable, flexible web.

10. The barrier system of claim 1, wherein the connector is a barrier wall.

11. The barrier system of claim 10, wherein the barrier wall further comprises at least one display element configured and operable to display merchandise, and the display device displays information regarding the merchandise.

12. A stanchion for use in a barrier system comprising:
a base;
a vertical post extending up from the base; and
a display device mounted on the vertical post at substantially eye level.

13. The stanchion of claim 12, wherein the display device is a liquid crystal display.

14. The stanchion of claim 13 further comprising a memory element operable to store information for display on the display device.

15. The stanchion of claim 14 further comprising a power source operable to power the display device.

16. The stanchion of claim 15, wherein the display device is a touch screen display operable to allow a user to input information.

17. The stanchion of claim 15, wherein the display device further comprises at least one input device operable to input information into the display device.

18. The stanchion of claim 15, wherein the display device further comprises a sensor configured and operable to detect a user's presence near the display device.

19. The stanchion of claim 18, wherein the power provided to the display device is controlled based on the presence of the user near the display device.

20. A stanchion for use in a barrier system comprising:
a base;
a vertical post extending up from the base; and
a display device mounted on the vertical post at substantially eye level,
wherein the display device is a touch screen display operable to allow a user to input information.

21. The stanchion of claim 20, wherein the display device is a liquid crystal display.

22. The stanchion of claim 20 further comprising a memory element operable to store information for display on the display device.

23. The stanchion of claim 22 further comprising a power source operable to power the display device.

24. The stanchion of claim 23, wherein the display device further comprises a sensor configured and operable to detect a user's presence near the display device.

25. The stanchion of claim 24, wherein the power provided to the display device is controlled based on the presence of the user near the display device.
